(19) United States
(12) Patent Application Publication
(10) Pub. No.: US 2026/0302708 A1
(43) Pub. Date: Oct. 1, 2026

(54) METHOD OF PRODUCING A BRUSH

(71) Applicant: ABB Schweiz AG, Baden (CH)

(72) Inventors: Jian Qin, Västerås (SE); Su Zhao, Västerås (SE); David Lindell, Hägersten (SE)

(21) Appl. No.: 19/569,569

(22) Filed: Mar. 17, 2026

(30) Foreign Application Priority Data
Mar. 28, 2025 (EP) 25166876.0

(51) Int. Cl. H01R 43/12; B21B 1/16; B21C 1/00; B22F 3/105; B22F 3/15; C22C 9/00

(52) U.S. Cl. CPC H01R 43/12; B21B 1/16; B21C 1/003; B22F 3/105; B22F 3/15; C22C 9/00; B22F 2301/10; B22F 2302/40; B22F 2304/10; B22F 2998/10; B22F 2999/00

(57) ABSTRACT

A method is disclosed for producing a brush configured to transmit electric current between a stationary part and a moving counterpart in an electrical machine. The method comprises dry mixing of powders to obtain a dry powder mixture comprising 0.5-5 wt. % of graphene and/or reduced graphene oxide, 0-3 wt. % of a non-metallic filler, balance copper or copper alloy powder, consolidating the dry powder mixture to form a composite material by subjecting the dry powder mixture to hot isostatic pressing or spark plasma sintering, cold working of the composite material, and forming the brush from the cold worked composite material.

### CROSS REFERENCE TO RELATED APPLICATIONS

The present application claims priority to European Patent Application No. 25166876.0 filed on Mar. 28, 2025, and titled “METHOD OF PRODUCING A BRUSH”, which is hereby incorporated by reference in its entirety.

### TECHNICAL FIELD

The technology disclosed herein relates generally to a composite material for a brush configured to transmit electric current between a stationary part and its moving counterpart, such as in an electric motor, and in particular to a method of producing such a brush comprising the composite material.

### BACKGROUND

In a brushed electrical machine such as a motor or a generator, a brush is used for conducting current to or from the rotating shaft of the machine. Typically, a rotating contacting component, such as a slip ring or a commutator, is fixed to the rotating shaft and remains in contact with a stationary part of the machine via the brush. The brush, often made of carbon or a metal-graphite blend, is pressed against the contacting component by a spring to ensure good electrical contact. The material of the brush should provide sufficient conductivity to transfer the needed current to or from the rotating contacting component, and low friction to keep the rotating contacting component intact.

The main drawback of existing brushes is that they wear out over time and need to be replaced to ensure proper functionality. Depending on the application, electrical brushes usually need to be replaced every 6 to 12 months, generating high maintenance costs during the entire lifetime of electrical machines.

Moreover, due to the wear of the brushes of carbon, dust is created, which can lead to clogging or electrical bridging.

A common practice to prolong the lifetime of brushes is to limit the contact pressure between the brush and the rotating contacting component to a very low level, for example 20-25 kPa. Because the contact resistance is inversely proportional to the contact pressure, the electrical losses at the contact region are relatively high. Another limitation of the commercial graphite containing electrical brushes is that the frictional performance is sensitive to humidity which limits the application to less humid environments.

### BRIEF DESCRIPTION

A primary objective of embodiments herein is to provide a method for producing a brush configured to transmit electric current between a stationary part and a moving counterpart that solves or at least mitigates the problems of the prior art. The embodiments and features, if any, described in this specification that do not fall under the scope of the independent claim are to be interpreted as examples useful for understanding various embodiments of the present disclosure. These objects are achieved by the subject-matter of the independent claims. Further exemplary embodiments are evident from the dependent claims and the following description.

According to a first aspect, at least the primary objective is accomplished by a method of producing a brush configured to transmit electric current between a stationary part and a moving counterpart according to claim 1. The method comprises:
a) dry mixing of powders to obtain a dry powder mixture comprising, in weight percent (wt. %):
   0.5-5 wt. % in total of graphene and/or reduced graphene oxide;
   in some embodiments, up to 3 wt. % of a non-metallic filler; and
   balance copper (Cu) or copper alloy powder having an average particle size of 10-500 μm;
b) consolidating the dry powder mixture to form a composite material by subjecting the dry powder mixture to one of:
   hot isostatic pressing at a temperature of 650-950° C. and under a pressure of 100-200 MPa, such as 150-200 MPa, for at least 1 hour, such as 1-3 hours; or
   spark plasma sintering at a temperature of 650-950° C. and under a pressure of 10-100 MPa for at least 2 minutes, such as 2-20 minutes;
c) cold working of the composite material; and
d) forming the brush from the cold worked composite material.

Cold working comprises plastically deforming the composite material at a temperature below its recrystallisation temperature. By cold working the composite material from which the brush is formed, a number of advantageous of the final material may be achieved. First, the cold working increases the strength of the composite material, thereby reducing wear on the brush. Cold working may increase the strength by a factor of two, without negatively impacting electrical properties of the composite material. Second, the cold working may reduce the tendency of the composite material to flake during wear, since the metal matrix of the composite material is already pre-deformed by the cold working process. Third, an improved homogeneity may be achieved, since the relatively large plastic strain induced by the cold working process facilitates breakup of agglomerates of graphene and, when present, non-metallic filler, improving the particle distribution and closing any remaining voids from the consolidation process. The improved homogeneity may improve the build-up of a tribological film and lower the wear rate of the brush.

The composite material exhibits advantageous tribological properties including low friction and high wear resistance in comparison with the known brushes such as, for example, commercial graphite-containing brushes. Thus, the brush produced by the first aspect of the disclosure exhibits well-balanced properties related to conducting electricity effectively while also resisting deterioration from friction and minimizing the material loss due to wear. This contributes to a more reliable and efficient operation of the device in which the brush is used. Due to the improved properties of the brush produced by the first aspect of the present disclosure, the contact pressure between the brush and the moving counterpart can be increased, leading to reduced contact resistance and voltage drop, and thereby also reduced electrical loss during use.

The composite material thus provides low friction, good electrical conductivity and additionally less wear which leads to an extended lifetime of the brush. Reduced voltage drop and contact resistance also opens up the possibility to increase the current carrying capacity. Unlike the graphite-containing commercial brushes which are sensitive to humidity change, the present composite material is more robust and may be operated at a broad humidity and temperature range.

The brush produced by the first aspect of the present disclosure may consist of the composite material, in other words, the whole brush may be made out of the composite material. As an alternative, the brush may comprise a support to which the composite material is attached, for example, as a composite material layer.

Typically, the brush produced by the first aspect of the present disclosure comprises a contacting surface configured to be in contact with the moving counterpart during use. Therefore, the composite material may be referred to as a composite contacting material.

The dry powder mixture comprises graphene, or reduced graphene oxide, or a combination of graphene and reduced graphene oxide, in a total amount of 0.5-5 wt. %.

Herein the term graphene is used collectively for carbon atoms in a 2D-honeycomb lattice in the form of mono-layer sheets, bi-layer sheets, few (3-5 layers) layer sheets, or nano-platelets having a thickness of at most 50 nm, for example, within the range of 1 to 50 nm. Thus, the graphene may be referred to as 2D material. The graphene is, in some embodiments, pure graphene.

The term reduced graphene oxide refers to graphene oxide which has been processed to reduce the oxygen content. In the present disclosure, the term reduced graphene oxide refers to graphene oxide containing less than 25 wt. % of oxygen, in some embodiments, less than 22 wt. %, and in some further embodiments, less than 18 wt. %. Similar to pure graphene, it may be referred to as a 2D material.

Spark plasma sintering (SPS) or hot isostatic pressing (HIP) is used to consolidate the dry powder mixture and form the composite material. By using spark plasma sintering or hot isostatic pressing, the density of the composite material will be high enough to be used as a brush in an electrical machine.

In case spark plasma sintering is used for producing the composite material, the high speed of the spark plasma sintering process ensures that it can densify powders with small particle size while avoiding coarsening which accompanies standard densification processes, such as non-spark plasma sintering techniques. Samples of composite material produced by this method have shown to have a compact density between 80 to 99% of the theoretical density of pure copper. Due to the rapid nature of the spark plasma sintering process, which is characterized by a high heating rate and short sintering time, typically only a couple of minutes, the composite material retains the structure of the graphene or reduced graphene oxide. The risk of deteriorating the lubricating and electrical properties of the graphene is thereby reduced. The spark plasma sintering has a duration of at least 2 minutes, such as at least 3 minutes, or at least 5 minutes. The duration may in some embodiments be at most 20 minutes, such as at most 15 minutes, such as at most 10 minutes.

Hot isostatic pressing typically comprises the following activities: placing the material mixture in a holder, for example, a metal capsule, and placing the holder with the material mixture in a HIP furnace having an inert atmosphere (for example, a He-atmosphere). Thereafter, the consolidation of activity b) is performed for at least 1 hour, such as 1-3 hours, in some embodiments, at least 2 hours. Finally, the holder (for example, the metal capsule) is machined away. During hot isostatic pressing, the material mixture is subjected to the same pressure in all directions compared to a uniaxial sintering process. The composite material produced using HIP may, after consolidation, exhibit a compact density over 90% relative to the theoretical density of pure copper, and a higher hardness compared to an electric brush produced by conventional sintering, or even spark plasma sintering. The brush produced using hot isostatic pressing followed by cold working therefore exhibits advantageous tribological properties in comparison with a brush produced by conventional sintering, or even spark plasma sintering.

The average particle size of the copper or copper alloy powder used in activity a) is 10-500 μm. The average size herein refers to a volume-based particle size, such as used in, for example, sieve analysis, wherein the particle size equals the diameter of the sphere that has the same volume as a given particle. According to one embodiment the copper or copper alloy powder has a particle size of at least 15 μm, such as at least 30 μm, at least 50 μm, at least 100 μm, or at least 200 μm, and a particle size of at most 500 μm, such as at most 450 μm, at most 400 μm, at most 350 μm, or at most 300 μm. The particle size of the copper or copper alloy powder may be referred to as the grain size of the copper or copper alloy powder.

When copper alloy powders are used, the particles within the powder are typically already alloyed.

In some embodiments, the composite material is free of graphite. The brush may also be free of nickel and/or free of chromium. Thus, according to one embodiment, the composite material is nickel-free and/or chromium-free and/or graphite-free.

In some embodiments, the cold working is performed at a temperature 200° C. or less, in some embodiments, at a temperature 100° C. or less, and in some further embodiments, at a temperature of 10-50° C. Cold working may, in some embodiments, be performed at room temperature.

In some embodiments, the cold working comprises cold working the composite material to an equivalent plastic strain of at least 0.2, in some embodiments, of at least 0.3, and in some further embodiments, of at least 0.4. By cold working to the equivalent plastic strain of at least 0.2, an improved homogeneity may be ensured. Further improvements in homogeneity may be achieved by cold working to the equivalent plastic strain of at least 0.3, or 0.4. The equivalent plastic strain ε_{eq} describes the degree of work hardening in the composite material and is defined as

$${ε}_{e q} = \sqrt{\frac{2}{3} ( {ε}_{1}^{2} + {ε}_{2}^{2} + {ε}_{3}^{2} - {ε}_{1} {ε}_{2} - {ε}_{2} {ε}_{3} - {ε}_{1} {ε}_{3} )}$$

wherein ε₁, ε₂, and ε₃ are principal plastic strains.

In some embodiments, the cold working comprises cold working the composite material to a Vickers hardness HV0.5 of at least 100 HV0.5, in some embodiments, of at least 110 HV0.5, and in some further embodiments, of at least 120 HV0.5. With these hardnesses, system wear may be significantly reduced, improving service life of the brush.

In some embodiments, the cold working comprises cold working the composite material to a final thickness of at least 3 mm, in some embodiments, of at least 5 mm. The desired final thickness depends on the application in which the brush is to be used, for example, motor size, and may in some cases be several centimeters.

In some embodiments, the graphene is added in the form of a dry graphene nanoplatelet powder, and/or the reduced graphene oxide is added in the form of a reduced graphene oxide nanoplatelet powder. Graphene nanoplatelets and reduced graphene nanoplatelets are low-cost materials which suffice for the purpose of making the composite material. Typically, the nanoplatelets are visible under electron microscope in the composite material.

In some embodiments, the graphene is added in the form of graphene particles each having a surface area in a range of 100-750 m²/g. For example, the graphene may be graphene nanoplatelets each having a surface area in a range of 100-750 m²/g. However, it should be mentioned that the graphene particles may be graphene nanopowder, or graphene flakes.

In some embodiments, the dry powder mixture comprises a total of 1-3 wt. % of graphene and/or of reduced graphene oxide. The dry powder mixture may comprise a mix of graphene and reduced graphene oxide, or graphene only (and no reduced graphene oxide), or reduced graphene oxide only (and no graphene). Hence, the total amount of a combination of graphene and graphene oxide, or the total amount of graphene, or the total amount of graphene oxide, is in these embodiments 1-3 wt. %. It has been found that this range of graphene and/or of reduced graphene oxide provides an advantageous trade-off between cost, and lubrication and wear resistance properties, while accounting for the risk of graphene turning into graphite.

The dry powder mixture may be free of the non-metallic filler, or it may comprise up to, and including, 3 wt. % of the non-metallic filler. Hence, the dry powder mixture comprises 0-3 wt. % of the non-metallic filler.

In some embodiments, the non-metallic filler comprises a transition-metal dichalcogenide powder and/or a hexagonal boron nitride powder. Hexagonal boron nitride and transition-metal dichalcogenides may, similar to graphene, be added in the form of 2D material powders in which powder particles comprise only a few atomic layers, such as in the form of nano-platelets having a thickness of at most 50 nm, for example, within the range of 1 to 50 nm. By including at least one of these in the powder mixture, a further increased strength of the composite material may be achieved. The powder may be in the form of a nanoparticle powder.

In some embodiments, the non-metallic filler comprises a ceramic nanoparticle powder selected from the group consisting of aluminum oxide, silicon oxide, yttrium oxide, silicon carbide, and tungsten carbide nanoparticle powders. Such ceramic nanoparticles may improve the strength of the composite material, while maintaining excellent dry lubricating properties and good electrical conductivity. For example, the ceramic nanoparticle may be aluminum oxide. The addition of a non-metallic filler is particularly advantageous when spark plasma sintering is used for consolidating the dry powder mixture in activity b.

Typically, an average particle size, such as an average diameter, of the ceramic nanoparticle powder may be 5-100 nm, such as 5-50 nm. The average size may, for example, be determined using an electron microscope according to know methods. For example, the size of the ceramic nanoparticles may be determined by Transmission Electron Microscopy (TEM), Dynamic Light Scattering (DLS) or Scanning Electron Microscopy (SEM). However, there are other ways of determining the size of the ceramic nanoparticles, such as the Brunauer-Emmett-Teller (BET) surface area analysis and subsequent calculation of the average particle size. The size determination of the ceramic nanoparticles is typically performed on dry particles.

In some embodiments, the dry powder mixture comprises 1 wt. % or less of the non-metallic filler, in some embodiments, 0.8 wt. % or less. By keeping the non-metallic filler at or below these upper limits, low friction may be ensured.

In some embodiments, the dry powder mixture comprises at least 0.2 wt. % of the non-metallic filler, in some embodiments, at least 0.5 wt. %. By including the non-metallic filler in the powder mixture, the composite material may exhibit advantageous tribological properties in comparison with a brush comprising a copper-graphene composite material without the non-metallic filler, such as in the form of ceramic nanoparticles. For example, the advantageous tribological properties may include low friction and high wear resistance. Due to the low wear nature of the copper-graphene-ceramic nanoparticles composite material, the contact pressure between the electric brush and the moving counterpart may be further increased, leading to reduced contact resistance and voltage drop, and thereby also reduced electrical loss during use. Typically, the mixing of the ceramic nanoparticles with the copper or copper alloy powder and the graphene and/or the reduced graphene oxide is included in the previously described dry mixing.

In some embodiments, the balance in the dry powder mixture is a copper alloy powder, the copper alloy powder being in the form of a bronze powder. The bronze powder typically comprises at least 85 wt. % copper, the remainder being tin (Sn) and in some embodiments, other alloying elements such as aluminum (Al), manganese (Mn), nickel (Ni), and/or zinc (Zn). Thus, the composite material produced in activity b) may comprise, or consist of, the bronze and the graphene and/or reduced graphene oxide, and in some embodiments, the non-metallic filler. In other embodiments, the copper alloy powder may be in the form of a brass powder comprising Cu and Zn, a cupronickel powder comprising Cu, Ni and Mn, or a Nordic gold powder comprising Cu, Zn, Al and Sn.

In some embodiments, the balance in the dry powder mixture is a copper alloy powder, the copper alloy comprising a total of 5 wt. % or less of one or more alloying element selected from phosphorus (P), zirconium (Zr), chromium (Cr), niobium (Nb), nickel (Ni), silicon (Si), titanium (Ti), the balance of the copper alloy being copper (Cu) and unavoidable impurities. With such an alloy, a desired precipitation hardening and/or retardation of recrystallisation may be achieved.

In some embodiments, consolidating of the dry powder mixture is performed under an inert atmosphere, such as under a He atmosphere. An inert atmosphere may be used regardless of which one of the mentioned consolidation processes is applied. The inert atmosphere eliminates the risk of oxidation of the composite material and thereby prevents the electrical conductivity of the composite material from being negatively affected.

In some embodiments, the cold working comprises cold rolling and/or cold extrusion. Other alternatives include bending, shearing, drawing, and equal channel extrusion. According to a second aspect, a brush configured to transmit electric current between a stationary part and a moving counterpart is provided, the brush being produced by the method according to the first aspect.

According to a third aspect of the disclosure, an electric motor or generator comprising a stationary part and a moving counterpart is provided. The motor or generator comprises a brush of the second aspect of the disclosure, wherein the brush is configured to transmit electric current between the stationary part and the moving counterpart. Thus, the brush typically forms part of the stationary part of the motor or generator, and the moving counterpart may form part of a rotating shaft.

Effects and features of the second and third aspects of the disclosure are largely analogous to those described above in connection with the first aspect of the disclosure. Embodiments mentioned in relation to the first aspect of the present disclosure are largely compatible with the second and third aspects of the present disclosure, of which some are exemplified below.

The motor or generator may, for example, be a wind turbine generator such as a doubly fed wind turbine generator, a slip ring modular motor, a (large) synchronous motor, and a non-magnet based brushed synchronous motor. The motor or generator may, for example, be a stationary motor or generator, or may be used in moving applications, such as, for example, in electric vehicles (EVs).

According to one embodiment, the moving counterpart is a slip ring or a commutator.

Generally, all terms used in the claims are to be interpreted according to their ordinary meaning in the technical field, unless explicitly defined otherwise herein. All references to “a/an/the element, apparatus, component, means, etc. are to be interpreted openly as referring to at least one instance of the element, apparatus, component, means, etc., unless explicitly stated otherwise.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, action, etc.” are to be interpreted openly as referring to at least one instance of the element, apparatus, component, means, module, action, etc., unless explicitly stated otherwise. The actions of any method disclosed herein do not have to be performed in the exact order disclosed, unless explicitly stated.

### BRIEF DESCRIPTION OF DRAWINGS

The subject matter of the present disclosure will be explained in more detail in the following text with reference to exemplary embodiments which are illustrated in the attached drawings.

FIG. 1 is a schematic side view of an electric motor comprising a brush configured to transmit electric current between a stationary part of the motor and its moving counterpart according to one example.

FIG. 2 is a flowchart illustrating a method of producing a brush according to one example.

FIG. 3 shows SEM images of composite materials after consolidation according to some examples.

FIG. 4 illustrates results of a wear rate test of composite materials after consolidation according to some examples.

FIG. 5 illustrates results of another wear rate test of composite materials after consolidation according to some examples.

The drawings are schematic and not necessarily drawn to scale. The reference symbols used in the drawings, and their meanings, are listed in summary form in the list of reference symbols. In principle, identical parts are provided with the same reference symbols in the figures.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. In some instances, the same or similar components may be assigned a different reference number, for example, due to a different configuration within the electronic circuit. Generally, only the differences with respect to the individual embodiments are described. Unless specified otherwise, the description of a part or aspect in one embodiment applies to a corresponding part or aspect in another embodiment as well.

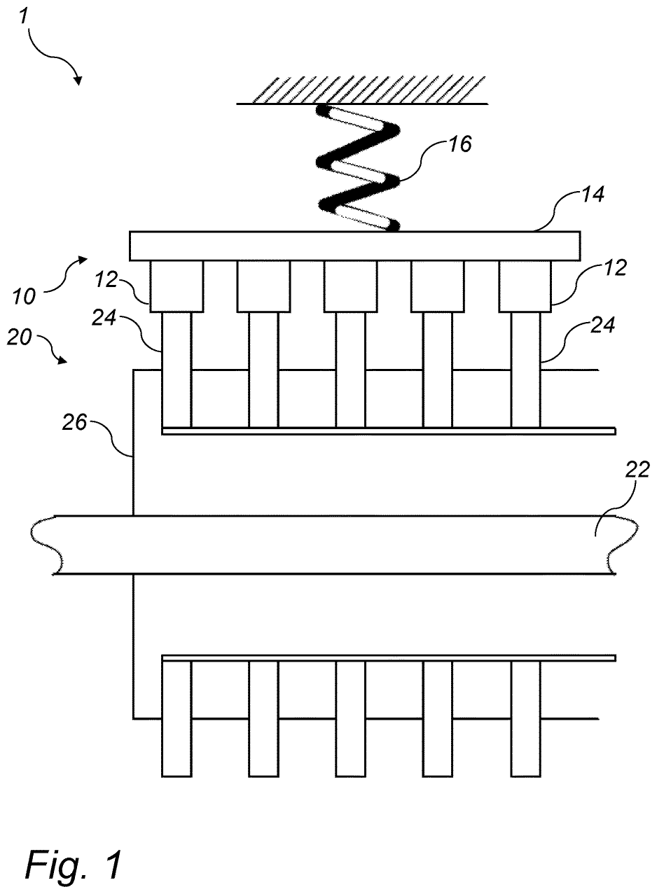

FIG. 1 depicts an electric motor 1 comprising a stationary part 10 and a moving counterpart 20. The moving counterpart 20 comprises a rotating shaft 22 and a plurality of rotating contacting components, here exemplified as slip rings 24, mounted in a support 26. The support 26 is attached to the shaft 22. Correspondingly, the stationary part 10 comprises a plurality of associated brushes 12. The brushes 12 are in FIG. 1 mounted to a holder 14, and are pushed against the slip rings 24 by means of a force member 16, such as one or more mechanical springs. The contact pressure may be higher than 25 kPa, such as 30 kPa or higher than 30 kPa, for example equal to or higher than 35 kPa or equal to or higher than 40 kPa, such as equal to or higher than 45 kPa. According to some examples, the contact pressure may be equal to or higher than 100 kPa, for example equal to or higher than 250 kPa, or even in the MPa range.

Thus, each brush 12 is arranged in mechanical and electrical contact with a respective slip ring 24. Thus, the brushes 12 are arranged stationarily and the slip rings 24 are rotated concurrently with rotation of the shaft 22.

The brushes 12 are pressed radially inwards towards its associated slip ring 24 by means of the force member 16. The brushes 12 are configured to transmit electric current between the stationary part 10 and the moving counterpart 20 via the slip rings 24. For example, the brushes 12 are configured to transmit electric current from the stationary part 10 to the moving counterpart 20 via the slip rings 24. However, it should be mentioned that the electric motor 1 may be operated in reverse, and thus function as a generator.

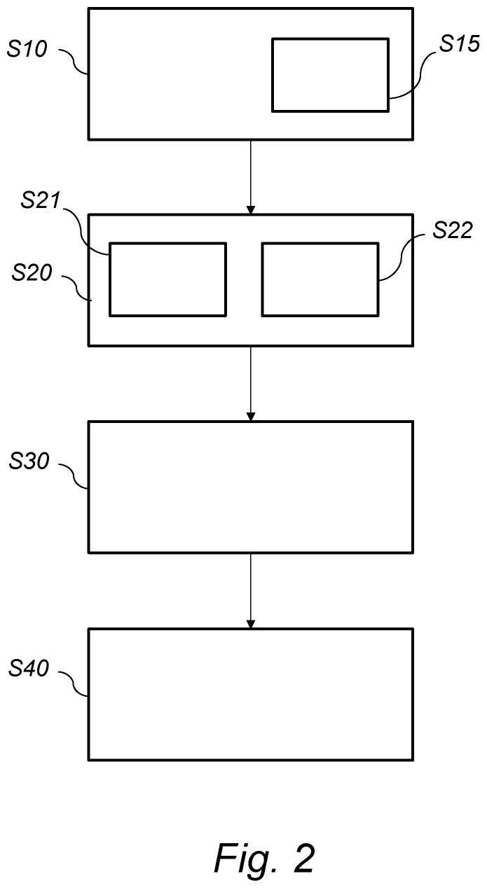

A method for producing a brush comprising a composite material, such as the brush 12 of FIG. 1, will now be described with reference to FIG. 2.

The method generally comprises producing a cold worked composite material, which is shaped or formed as a brush 12.

In an activity a), or a first activity S10, the method comprises dry mixing of powders to obtain a dry powder mixture comprising, in weight percent (wt. %): 0.5-5 wt. % of graphene and/or reduced graphene oxide, in some embodiments, 0-3 wt. % of a non-metallic filler, and balance copper powder or copper alloy powder having an average particle size of 10-500 μm, such as 30-200 μm, or 40-150 μm, or 50-100 μm. The graphene or reduced graphene oxide may be in the form of graphene or reduced graphene oxide particles each having a surface area in a range of 100-750 m²/g. The graphene is, in some embodiments, in the form of graphene nanoplatelets.

The non-metallic filler may comprise a 2D-material such as a transition-metal dichalcogenide powder and/or a hexagonal boron nitride powder.

Alternatively, or additionally, it may comprise a ceramic nanoparticle powder selected from the group consisting of aluminum oxide, silicon oxide, yttrium oxide, silicon carbide, and tungsten carbide nanoparticle powders. The dry powder mixture may, in some embodiments, comprise 1 wt. % or less of the non-metallic filler, and in some further embodiments, 0.8 wt. % or less. When the non-metallic filler is added, it may, in some embodiments, be added in an amount of at least 0.2 wt. %, and in some further embodiments, at least 0.5 wt. %.

The dry mixing in the first activity S10 may comprise ball milling or other extensive mixing techniques, in some embodiments, mechanical mixing techniques. For example, the powder mixture is achieved by vigorously mixing, for example, using a high-speed shaker. According to one example, the shaking speed may be 700 rpm and the mixing time may be 150 seconds. The mixing time may vary depending on the amount of material mixed.

The first activity S10 may comprise the sub-activity S15 of mixing a first sub-set of the copper or copper alloy powder having a first average particle size with a second sub-set of the copper or copper alloy powder having a second average particle size, wherein the first and second average particle size differ from each other by at least 50 μm. Hereby, copper or copper alloy powder, and other components of the powder mixture, may be more densely packed.

In an activity b), or a second activity, S20, occurring subsequent to the first activity S10, the dry powder mixture obtained in the first activity S10 is consolidated to form a composite material. The consolidation is carried out either by subjecting the dry powder mixture to hot isostatic pressing (HIP) in an activity S21, or by subjecting the dry powder mixture to spark plasma sintering (SPS) in an activity S22. When the dry powder mixture does not comprise any non-metallic filler, HIP is, in some embodiments, but not necessarily, used. When the dry powder mixture comprises the non-metallic filler, either HIP or SPS may be used.

In the activity S21, the HIP is carried out at a temperature of 650-950° C. and under a pressure of 100-200 MPa, in some embodiments, 150-200 MPa, for at least 1 hour, such as 1-3 hours. Thus, in the activity S21, the dry powder mixture is sintered by hot isostatic pressing. During the HIP, the material mixture is placed in a holder, typically a metal capsule, whereafter the holder with the dry powder mixture is subjected to the hot isostatic pressing. The sintering is typically performed in a HIP furnace with inert atmosphere, such as a He-atmosphere. Finally, the holder (for example, the metal capsule) is machined away.

In the activity S22, the SPS is carried out at a temperature of 650-950° C. and under a pressure of 10-100 MPa for at least 2 minutes, such as 2-20 minutes. The sintering is typically performed under inert atmosphere, such as under a He-atmosphere.

In an activity c), or a third activity S30 carried out after the consolidation in the second activity S20, the method comprises cold working of the composite material obtained in the second activity S20. The cold working is performed at a temperature below the recrystallization temperature of the metal matrix of the composite material. In some embodiments, the cold working is performed at a temperature of 200° C. or less, in some embodiments, at a temperature of 100° C. or less, and in some further embodiments, at a temperature of 10-50° C. The composite material may be cold worked to an equivalent plastic strain of at least 0.2, in some embodiments, of at least 0.3, and in some further embodiments, of at least 0.4. It may be cold worked to a Vickers hardness HV0.5 of at least 100 HV0.5, in some embodiments, of at least 110 HV0.5, and in some further embodiments, of at least 120 HV0.5, wherein the Vickers hardness is determined according to ISO 6507 for a load of 500 g (HV0.5) valid on the date of priority for the present patent application. The composite material may, depending on the application in which the brush is to be used, be cold worked to a final thickness of at least 3 mm, in some embodiments, of at least 5 mm, by using one or more cold working techniques such as cold rolling, cold extrusion, bending, shearing, drawing, and/or equal channel extrusion. Typically, the cold working comprises cold rolling. The method should, in some embodiments, not comprise any hot working of the composite material.

In an activity d) or fourth activity S40, carried out after the cold working in the third activity S30, the brush is formed from the cold worked composite material. This typically comprises cutting and/or machining the cold worked composite material into a desired shape.

### Examples

Eight different samples were prepared and analyzed with regards to specific material parameters as summarized in Table I. Each sample correspond to the previously described composite material prior to cold working.

The samples were prepared by mixing copper powder with graphene powder. The copper powder comprised spherical copper particles with a particle size distribution in which at least 90% of the particles have a diameter of 75 μm. Two different graphene powders were used, coarse graphene nanoplatelets having a specific surface area (SSA) of 120-150 m²/g, and fine graphene nanoplatelets having a specific surface area of 750 m²/g. The powders were dry mixed. Subsequently, for some of the samples, ceramic nanoparticles, Al₂O₃, with an average diameter of less than 50 nm as determined by transmission electron microscopy (TEM) were added to the dry copper-graphene powder mixture, also by dry mixing. For the mixing, a paint shaker model SK35 from Fast & Fluid was used.

The dry powder mixtures were then sintered using either spark plasma sintering (Fuji Electronics, Dr. Sinter SPS530ET with graphite furnace) or hot isostatic pressing (Quintus Technologies, HIP QIH9 with graphite furnace) into composite materials to be subjected to cold-working and subsequently used as electric brushes. For the spark plasma sintering, the dry powder mixtures were added to the graphite furnace, heated up to a predetermined temperature of 660° C. at a rate of about 75° C. per minute. At the predetermined temperature, the samples were subjected to spark plasma sintering at a pressure of 60 MPa for approximately 10 minutes. For hot isostatic pressing, the dry powder mixtures were placed in a holder, here a metal capsule, whereafter the holder with the dry powder mixture was placed in a HIP furnace with inert atmosphere (He-atmosphere) and subjected to hot isostatic pressing at a pressure of 180 MPa and at a temperature of 750° C. for 3 hours. Finally, the holder was machined away.

TABLE I

| | Cu, | Graphene | Graphene | Al₂O₃, | Sintering |
|---|---|---|---|---|---|
| Sample | wt. % | (fine), wt. % | (coarse), wt. % | wt. % | process |
| SPS-1 | 99 | — | 1 | — | SPS |
| SPS-2 | 97 | — | 3 | — | SPS |
| SPS-3 | 98.5 | — | 1 | 0.5 | SPS |
| SPS-4 | 97 | — | 2.5 | 0.5 | SPS |
| HIP-1 | 99 | 1 | — | — | HIP |
| HIP-2 | 97 | 3 | — | — | HIP |
| HIP-3 | 99 | — | 1 | — | HIP |
| HIP-4 | 97 | — | 3 | — | HIP |

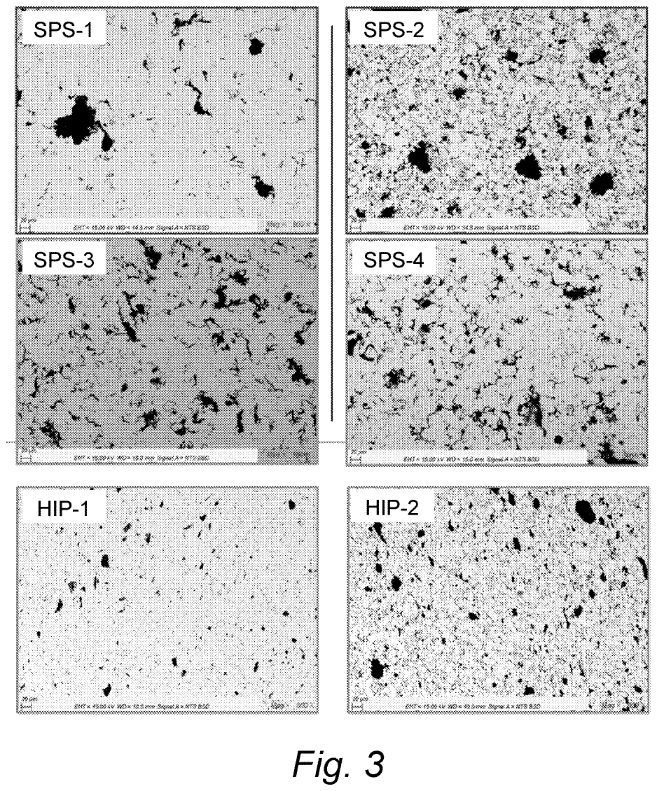

Scanning electron microscopy (SEM) images of the samples SPS-1, SPS-2, SPS-3, SPS-4, HIP-1 and HIP-2 are presented in FIG. 3. The bar in the lower left corner of each image represents a distance of 20 μm. As can be seen from the SEM images, the copper graphene composite produced through spark plasma sintering, samples SPS-1, SPS-2, SPS-3 and SPS-4, retains the structure of the graphene material and is almost free from aggregation. Homogenous distribution of graphene flakes and, where applicable, Al₂O₃ nanoparticles at the grain boundary is shown in the SEM images. As can be further seen from the SEM images, the copper-graphene composite material produced through hot isostatic pressing, samples HIP-1 and HIP-2, retains the structure of graphene material and is almost free from aggregation. The homogenous distribution of graphene flakes at the grain boundary revealed in FIG. 3 is believed to contribute to increased strength of the composite material. That is, the increased strength could be partially due to grain-boundary strengthening of graphene sheets that are distributed around the grain boundary, serving as a barrier for dislocations.

The cold working will further improve the particle distribution within the composite material and further lower wear rates of the finished brush.

The Vickers hardness of the various samples after consolidation, prior to cold working, is presented in Table II, including standard deviation (std). The cold working will further increase the hardness by at least by a factor of two. Hence, hardnesses of at least 100 HV0.5 are expected (the sample SPS-3 being a slight exception resulting in hardness of 96 HV0.5 if increase by a factor of two is assumed) after the third activity S30 of cold working of the composite material.

TABLE II

| | HV0.5 | Contact |
|---|---|---|
| Sample | (std) | resistance at 40N |
| SPS-1 | 54 (1) | <2 mΩ, >1 mΩ |
| SPS-2 | 62 (2) | |
| SPS-3 | 48 (1) | <1 mΩ |
| SPS-4 | 55 (2) | |
| HIP-1 | 82 (3) | <2 mΩ |
| HIP-2 | 78 (4) | <2 mΩ |
| HIP-3 | 74 (2) | |
| HIP-4 | 68 (3) | |

The contact resistance vs contact force was evaluated for some of the samples as summarized in Table II. For the sample HIP-1, the contact resistance of was below 20 mΩ (milliohm) for a contact load of 10 N, below 8 mΩ for a contact load of 20 N, below 3 mΩ for a contact load of 30 N, below 2 mΩ for a contact load of 40 N, and even below 1 mΩ for a contact load of 50 N. For the sample HIP-2, the contact resistance was below 10 mΩ for a contact load of 10 N, below 4 mΩ for a contact load of 20 N, below 3 mΩ for a contact load of 30 N, and below 2 mΩ for contact loads of 40 N and 50 N, respectively. For the sample SPS-3, the contact resistance was below 10 mΩ for a contact loads over 2 N, and more specifically below 2 mΩ for a contact load of 20 N (approximately 1.5 mΩ), approximately 1 mΩ for a contact load of 30 N and below 1 mΩ for a contact load of 40 N and 50 N (approximately 0.7 mΩ and 0.5 mΩ, respectively). For the sample SPS-1, the contact resistance was just above 1 mΩ for a contact load of 50 N, above 1 mΩ but below 2 mΩ for a contact load of 40 N, and just above 2 mΩ for a contact load of 20 N. For a comparative example in the form of a graphite-copper brush, BGB, not produced by hot isostatic pressing, the contact resistance was above 20 mΩ for all contact loads of 0-50 N.

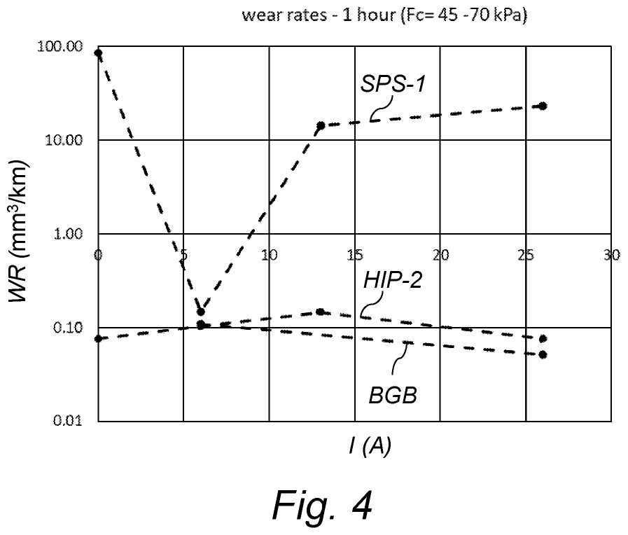

With reference to FIG. 4, the normalized wear rate WR as a function of current I was evaluated for the samples SPS-1, HIP-2 and the comparative example BGB mentioned above. As shown in FIG. 4, the wear rates for 1 hour were compared. It is evident that the normalized wear rate (mm³/km) for the sample HIP-2 is significantly superior to that of the sample SPS-1, and in parity with the sample BGB. For the sample HIP-2, the normalized wear rate is below 1 mm³/km for all measured currents 0-30 A, as compared to the sample SPS-1 exhibiting a normalized wear rate of over 1 mm³/km, and even over 10 mm³/km, for all measured currents except that of 6 A. Thus, the wear rate is significantly reduced, by more than one order of magnitude (mm³/km), owing to the hot isostatic pressing. However, cold working is expected to improve the strength of the sample SPS-1 and thereby significantly reduce the wear rate to achieve results at least similar to those achieved for the sample HIP-2 prior to cold working.

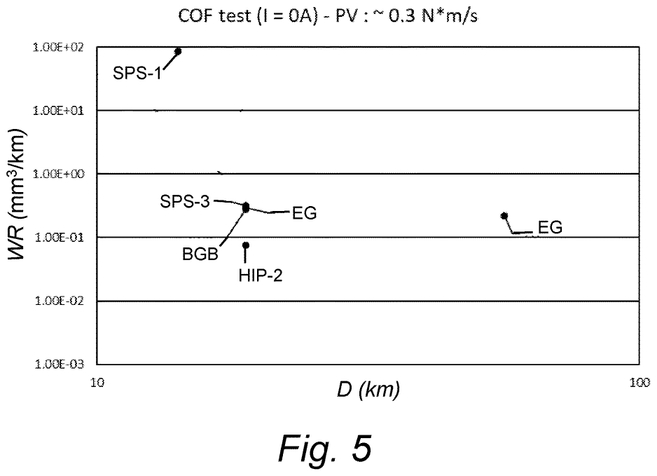

With reference to FIG. 5, the volume wear rate (WR) vs sliding distance (D) was evaluated for the samples SPS-1, SPS-3, HIP-2, BGB, and for a conventional electrographite brush EG. The volume wear rate WR was measured by weight loss of the sample after a certain sliding distance D as indicated on the horizontal axis. For the sample SPS-1, the test was interrupted after 20 km due to excessive wear, whereas the other samples were compared after 30 km. With reference to FIG. 5, it is evident that the volume wear rate as measured in mm³/km for the sample HIP-2 is superior to that of all other samples. For HIP-2, the volume wear rate is below 0.1 mm³/km as determined after a sliding distance of approximately 30 km, as compared to SPS-1 exhibiting a volume wear rate of close to 100 mm³/km as determined after a sliding distance of approximately 20 km. By comparing the samples SPS-1 and SPS-3, it is however evident that the addition of Al₂O₃ significantly reduces the volume wear rate. For the sample SPS-3, containing Al₂O₃, the volume wear rate is below 1 mm³/km for a sliding distance of 30 km, which is in parity with the BGB and EG samples. Thus, the wear rate is significantly reduced, by more than one order of magnitude (mm³/km), owing to the additional ceramic nanoparticles. As mentioned above, cold working is expected to significantly improve the strength of the sample SPS-1 produced by spark plasma sintering and thereby, after cold working, achieve a wear resistance at least similar to that of the HIP-2 as measured prior to cold working.

The previously mentioned Vickers hardness was determined in a Vickers hardness test according to ISO 6507 for a load of 500 g (HV0.5) valid on the date of priority for the present patent application.

The previously mentioned contact resistance vs contact force was performed according to the method as described in the following.

The contact resistances were measured between a corresponding flat surface of the sample materials against an Ag contact pin having a half spherical tip with a diameter of 10 mm. For the contact resistance measurements, a micro-ohmmeter MR 300 C-A from Schuetz-Messtechnik was used. The method used was a 4-point probe measurement method. Certain contact forces were applied during the CR measurement with a spring load measured by a load cell from Nobel Elektronik. The contact resistance was measured by the 4-point probe technique involving four equally spaced probes around the contact region. A DC current was applied between the outer two probes and a voltmeter measured the voltage difference between the two inner probes. The contact force between the contact surfaces (between flat surface of the sample and the half spherical tip of the Ag contact pin having a diameter of 10 mm) was manipulated with a screw connected to a spring load and monitored with force measuring transducer.

The previously mentioned normalized wear rate vs current was performed according to the method as described in the following.

The sample was prepared in a test rig including a stationary part and a moving counterpart. The sample was used as a brush contacting the moving counterpart during rotation of the latter. The applied power/contact pressure of the sample relative to the moving counterpart was 45-70 kPa. The current was varied from 0 to 26 A. The normalized wear rate was measured by weight loss of the sample after a certain traveling distance of the moving counterpart (in other words, the product of circumference of the moving counterpart, the rpm and the time).

The previously mentioned volume wear rate vs sliding distance was performed according to the method as described in the following.

The sample was prepared in a test rig including a stationary part and a moving counterpart. The sample was used as a brush contacting the moving counterpart during rotation of the latter. The applied contact force (N) multiplied with surface line speed (m/s) of the sample relative to the moving counterpart was 0.3 N*m/s. No current was applied. The volume wear rate was measured by weight loss of the sample after a certain traveling distance of the moving counterpart (in other words, the product of circumference of the moving counterpart, the rpm and the time).

It is noted that the wear rate of the brush depends on many parameters, such as contact pressure, electrical load, speed of the moving counterpart, state of the collector, ambient conditions etc. However, by applying the above method for the different samples and ensuring that the conditions and parameters are corresponding, comparison between the wear rates of the samples can be achieved.

In the claims, the word “comprising” does not exclude other elements or activities, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method of producing a brush configured to transmit electric current between a stationary part and a moving counterpart, the method comprising:
a) dry mixing of powders to obtain a dry powder mixture comprising, in weight percent (wt. %):
0.5-5 wt. % in total of graphene and/or reduced graphene oxide; and
balance copper or copper alloy powder having an average particle size of 10-500 micrometers (μm);
b) consolidating the dry powder mixture to form a composite material by subjecting the dry powder mixture to one of:
hot isostatic pressing at a temperature of 650 to 950 degrees Celsius (C) and under a pressure of 100 to 200 megapascal(MPa) for at least 1 hour; or
spark plasma sintering at a temperature of 650 to 950° C. and under a pressure of 10-100 MPa for at least 2 minutes;
c) cold working of the composite material; and
d) forming the brush from the cold worked composite material.

2. The method of claim 1, wherein the cold working is performed at a temperature of 200° C. or less.

3. The method of claim 1, wherein the cold working comprises cold working the composite material to an equivalent plastic strain of at least 0.2.

4. The method of claim 1, wherein the cold working comprises cold working the composite material to a Vickers hardness HV0.5 of at least 100 HV0.5.

5. The method of claim 1, wherein the cold working comprises cold working the composite material to a final thickness of at least 3 millimeters.

6. The method of claim 1, wherein the graphene and/or reduced graphene oxide is added in a form of a dry graphene nanoplatelet powder and/or a dry reduced graphene oxide nanoplatelet powder.

7. The method of claim 1, wherein the dry powder mixture comprises a total of 1 to 3 wt. % of graphene and/or reduced graphene oxide.

8-11. (canceled)

12. The method of claim 1, wherein the balance in the dry powder mixture is a copper alloy powder, the copper alloy comprising a total of 5 wt. % or less of one or more alloying element selected from P, Zr, Cr, Nb, Ni, Si, Ti, the balance of the copper alloy being Cu and unavoidable impurities.

13. The method of claim 1, wherein the consolidating of the dry powder mixture is performed under an inert atmosphere.

14. The method of claim 1, wherein the cold working comprises cold rolling and/or cold extrusion.

15. (canceled)

16. The method of claim 1, wherein activity a), dry mixing of the powders to obtain the dry powder mixture further comprises:
dry mixing the powders to obtain up to 3 wt. % of a non-metallic filler.

17. The method of claim 16, wherein the non-metallic filler comprises a transition-metal dichalcogenide powder and/or a hexagonal boron nitride powder.

18. The method of claim 16, wherein the non-metallic filler comprises a ceramic nanoparticle powder selected from the group consisting of aluminum oxide, silicon oxide, yttrium oxide, silicon carbide, and tungsten carbide nanoparticle powders.

19. The method of claim 16, wherein the dry powder mixture comprises 1 wt. % or less of the non-metallic filler.

20. The method of claim 16 wherein the dry powder mixture comprises at least 0.2 wt. % of the non-metallic filler.

21. The method of claim 1, wherein the cold working is performed at a temperature of 100° C. or less.

22. The method of claim 1, wherein the cold working is performed at a temperature of 10 to 50° C.

23. The method of claim 1, wherein the cold working comprises cold working the composite material to an equivalent plastic strain of at least 0.3.

24. The method of claim 1, wherein the cold working comprises cold working the composite material to an equivalent plastic strain of at least 0.4.

25. The method of claim 1, wherein the cold working comprises cold working the composite material to a final thickness of at least 5 millimeters.
